(19) United States
(12) Patent Application Publication
(10) Pub. No.: US 2006/0245809 A1
(43) Pub. Date: Nov. 2, 2006

(54) Printer with a media unit which can be removed therefrom and which is lockable

(75) Inventors: Heinz-Josef Hautvast, Brigachtal (DE); Axel Huegle, Furtwangen (DE); Thomas Riester, Villingen-Schwenningen (DE)

Correspondence Address: SIEMENS SCHWEIZ AG;I-47, INTELLECTUAL PROPERTY, ALBISRIEDERSTRASSE 245, ZURICH, CH-8047, CH

(73) Assignee: SIEMENS AKTIENGESELLSCHAFT, Munich (DE)

(21) Appl. No.: 10/554,056

(22) PCT Filed: Apr. 2, 2004
(86) PCT No.: PCT/EP04/03541

§ 371 Date: Oct. 24, 2005

(30) Foreign Application Priority Data
May 12, 2003 (DE) 103212337

(51) Int. Cl. B41J 15/00

(52) U.S. Cl. 400/613

(57) ABSTRACT

A printer is disclosed, especially for a tacograph for a motor vehicle, the printer including a housing, a print unit, a media unit which can be partially removed from the housing and a locking unit retaining the media unit. The print quality of conventional printers is subject to extreme fluctuations. The aim of the invention is to produce a printer which produces a good print image despite rough operating conditions. A locking element is included which can be moved translationally perpendicular to the direction of insertion into a locked position and into an unlocked position. A translationally displaceable locking element offers greater security in relation to shocks than a rotationally mounted locking element.

The invention relates to a printer, in particular the printer of a tachograph for a motor vehicle, having a housing, a printing unit, having a media unit to hold a medium that can be printed, which media unit can be moved relative to the printing unit along an insertion curve describing an insertion direction into an operating position and, counter to the insertion direction, out of an operating position, which media unit can be at least partly removed from the housing, which media unit can be locked in an operating position in the housing by means of a locking unit, which locking unit has at least one movable locking element which can be moved into a locked position and into an unlocked position, the locking element in the locked position engaging with at least one retaining element which is fixed to the housing.

The focus of the application of the device according to the invention is in the area of tachographs or devices for registering the working times and rest times of commercial vehicle drivers. However, other applications are likewise conceivable, for example in the area of banking and finance. Because of the legal verification function of the working time data registered by means of the tachograph, this data must be documented in an unchanging way in a forgery-proof format. The statutory standard provides for the data to be printed out by means of a printer on specific, forgery-proof paper, in order to develop a legal evidential character. Therefore, the quality and the functional reliability of the printer of a tachograph will have strict measures applied to them. In order to meet these high requirements, in view of the operating conditions of these devices, which are to some extent extreme, the development faces a very great challenge. The rough operating conditions are distinguished by extreme temperature fluctuations between −40° C. and 80° C. and, at the same time, high atmospheric humidity, as well as high vibration and shock stresses. In addition, generic devices are mounted in different installation positions, so that, with regard to the dynamic mechanical stresses, they must be able to withstand the loadings in virtually all spatial directions without the availability of the device being impaired. The rough operating conditions are additionally intensified by regularly less careful operation of the device. At the same time, the usual standards with regard to operating convenience have to be taken into account, for example changing the media under the rather adverse conditions in the driver's cab of a motor vehicle must not degenerate into fiddly manual work. In addition, the only little overall space available makes it more difficult to implement a secure function and convenient operation with ruggedness at the same time.

DP 102 15 122.9 has already disclosed a tachograph having a box-shaped housing and a generic printing device, in which the media unit can be removed from the housing for the purpose of reloading and can be fixed and locked in the housing by means of lock elements which interact with latching links. It is proposed to mount the lock element such that it can be rotated and to provide it with a latching hook which is assigned to a fixed-location latching link. Under the dynamic mechanical stresses already outlined, however, it has been shown that such a latching hook unlocks automatically in an unplanned manner, so that the media unit, which is formed in the manner of a drawer, unintentionally moves out of the housing of the tachograph. In this solution, the implementation is carried out in practice with two latching hooks, in each case arranged on one side of the media unit, the consequence of which is that from time to time only one latching hook is in engagement with the corresponding latching link, so that although the media unit is moved out of the operating position it is displaced, so that the printed image is impaired in an improper manner. In addition, the printing quality is subjected to high fluctuations.

Starting from the disadvantages and problems of the prior art, the object of the invention is to provide a printer of the type mentioned at the beginning which, despite the rough operating conditions, exhibits a low failure rate with a high level of operating convenience and produces a good printed image.

The achievement of the object according to the invention provides for the locking element to be capable of movement translationally transversely with respect to the insertion direction into a locked position and into an unlocked position.

It has been shown that a translationally movable locking element provides higher security against shocks than a rotatably mounted one. According to the invention, by means of the locking unit, it is not only possible to keep the media unit, which can be displaced in the manner of a drawer, in the locked position in the housing but also to stabilize it. With the effect of this double function, the locking unit aligns the media unit more accurately in the operating position. By contrast, a rotatably mounted latching hook additionally has the disadvantage that either particularly large overtravel during locking and unlocking processes must be provided or extremely high prestressing forces have to be applied to the latching hook in the direction of a locked position in order to ensure the necessary security against shocks. These bracing forces increase when the printing unit and/or the media unit. are prestressed counter to the insertion direction by means of a second resilient element and the locking unit must absorb these forces. Only the translational movement according to the invention transversely with respect to the insertion direction of the locking element ensures the necessary security against shocks.

An advantageous development of the invention provides for the printer to have two retaining elements arranged with a spacing from each other which, in the locked position, engage with at least one locking element. The use of two retaining elements with a spacing is distinguished by incomparably precise retention of the media unit in the housing of the printer. In this way, torques can also be transmitted to the locking unit and the stabilization of the media unit according to the invention becomes possible.

Expediently, the direction of the spacing between the two retaining elements extends at right angles to the direction in which the locking element or the locking elements can move. In this way, it is possible for forces occurring on the locking unit in the insertion direction not to move the locking element, for example out of the locked position. An orientation of the direction of the spacing between the retaining elements or of the force introduction regions of the forces from the locking elements is particularly expedient into the retaining elements arranged in a fixed manner in the housing, and perpendicular to the insertion direction and, in the case of two guides for the media unit extending in the insertion direction, a vertical orientation in relation to the plane described by these two guides. By means of such an arrangement of the locking unit, the media unit gains additional positional stability in the housing, since torques occurring in the housing transversely with respect to the insertion direction in the plane of the guides of the media unit can advantageously be absorbed by the locking unit and transmitted to the housing.

The critical advantage of the translational direction of movement transversely with respect to the insertion direction of the locking element of the locking unit resides in the extremely far-reaching decoupling of the movement of the locking element from forces acting in the insertion direction. Here, in addition to the shock loadings occurring during proper operation, the forces from an ejection spring or another resilient element forcing the media unit counter to the insertion direction are primarily of importance. In addition to the necessary force for the ejection, such a second resilient element also ensures a secured position of the media unit in the housing, despite the play of the media unit required for mobility. In particular in the case of an operating unit arranged on the front panel of the media unit in an expedient and space-saving manner and actuating the locking unit, a high ejection force counter to the insertion direction is required, since the magnitude of this force must exceed the finger pressure of the user when actuating the operating element initiating the ejection.

The locking unit advantageously has a first resilient element, which prestresses the locking element into the locked position. This arrangement, which is needed for shock resistance, can be improved still further according to the invention in terms of security against shocks since, on account of the decoupling of the forces of the movement of the locking unit from forces occurring in the insertion direction, the restoring force of the first resilient element, even in the case of operating elements arranged in a space-saving manner on the front panel of the media unit and initiating the ejection of the media unit, the operating force can be compensated for by means of a particularly powerful ejection spring. In addition, the restoring force from the ejection spring and the force from the first resilient element of the locking unit are linearly independent, which opens up new degrees of freedom for dimensioning.

Additional ruggedness is imparted to the locking unit according to the invention if the locking unit has a slide-mounted carriage, which carries at least one locking element and can be moved into a locked position and into an unlocked position. The locking element expediently extends substantially perpendicular to the direction of movement of the carriage.

For an extremely high level of stability, the carriage is designed to be elongated in the direction of movement, so that torques can also be transmitted to the sliding surface. In particular in the case of an elongated design, the carriage according to the invention is suitable as a carrier for at least one elongated locking element which extends with its longitudinal axis perpendicular to the direction of movement of the carriage. Given an elongated design of the carriage, torques oriented perpendicular to the longitudinal axis of the locking element and perpendicular to the direction of movement of the carriage can be transmitted from the media unit into the housing by means of the locking unit.

The transmission of torques oriented in the insertion direction from the media unit into the housing by means of the locking unit imparts the optimal stability to the arrangement primarily when two retaining elements arranged with a spacing from each other are provided and locking elements corresponding to these are fitted to the carriage, the direction of the spacing between the retaining elements expediently being oriented perpendicular to the direction of movement of the carriage and perpendicular to the insertion direction.

The transmission of higher supporting moments from the media unit to the locking unit in the insertion direction and transversely thereto is possible if the locking elements fixed to the carriage have at least two contact regions, with which they bear on the retaining elements in the locked position and the direction of the spacing between the two contact regions describes a straight line running substantially perpendicular to the direction of movement of the carriage.

Further stability in the location of the media unit is achieved if the carriage of the locking unit is slide-mounted on at least one sliding plane and the sliding plane extends between the two contact regions, so that at least one locking element is arranged on both sides of the sliding mounting of the carriage.

In relation to the ability to transfer the force components oriented in any direction from the media unit to the housing, it is advantageous if the two contact regions are located substantially on a single straight line described by a normal to the sliding plane of the carriage.

Optimal interaction between the locking unit and guides of the media unit, which can be displaced in the manner of a drawer, results if the media unit is mounted such that it can be displaced along the insertion curve in guides, the direction of the spacing between the two contact regions of the locking unit extending substantially in the direction of the normal to a tangential plane described there by the guides.

In order to ensure friction-free latching of the locking element in the associated retaining element, it is expedient if the locking element has a cylindrical shape, is elongated and the cylinder longitudinal axis runs perpendicular to the direction of movement. In the case of expediently hook-shaped retaining elements, a locking element designed in this way slides along the hook profile into the locked position virtually without friction.

For space-saving reasons, it is expedient if the movable locking elements on the media unit are constituents fixed to the media unit. Under the limited overall space conditions, it has proven to be expedient to provide the operating element actuating the locking element on the front panel of the media unit, which necessitates arranging the movable locking elements on the media unit. In the same way, it is expedient if the stationary retaining elements are permanently connected to the housing and interact in a locking manner with the locking elements on the media unit.

In order to avoid misprints, it is expedient if the movable parts of the locking unit interact with a sensor which registers a locked position, in which the media unit or the carrier and the printing unit are fixed in relation to each other in the direction of the spacing or, in a corresponding manner, an unlocked position.

Because of the arrangement according to the invention of locking elements on a common carriage, one sensor is advantageously sufficient for registering the state of the locking unit. As compared with the use of a plurality of sensors for a plurality of locking elements, this firstly has the advantage that component costs are saved and secondly the functional advantage that contradictory status messages cannot come from the locking unit.

The locking according to the invention gains special significance in interaction with a printing unit which can be moved in the housing within a movement play. A design of this type is able to increase the printing quality if means for aligning the printing unit in relation to the media unit are provided, so that the printing unit and the media unit are aligned with each other when the media unit is inserted in the insertion direction. The positional inaccuracy in relation to the printing unit resulting from the movement play of the media unit is in this way compensated for when it is inserted into the housing. The movement play of the printing unit in the housing extends primarily horizontally in the insertion direction, preferably with an order of magnitude of about 1 mm. In addition, a horizontal movement play transversely with respect to the insertion direction and of the same order of magnitude can be provided. A vertical movement play of about 0.5 mm transversely with respect to the insertion direction is expedient on account of the special importance for the printing quality. In interaction with a second resilient element, which pushes or pulls the printing unit counter to the insertion direction with a force, so that the force urges the printing unit against the media unit when the latter is inserted, so that the printing unit is aligned with the inserted media unit, the preferred spatial movement play reliably ensures a reproducible relative position of the media unit in relation to the printing unit. In a design of the locking unit having at least two retaining elements, special security against shocks and positional stability of the media unit are ensured if the retaining elements are arranged symmetrically in relation to the second resilient element. A design of the second resilient element in such a way that it prestresses the printing unit in the housing against stops limiting the movement play when the media unit is not in the operating position reliably prevents uncontrolled, possibly destructive, movements of the printing unit in the housing in the absence of the media unit.

In the following text, in order to illustrate the invention, a specific exemplary embodiment is described in more detail with reference to drawings, in which:

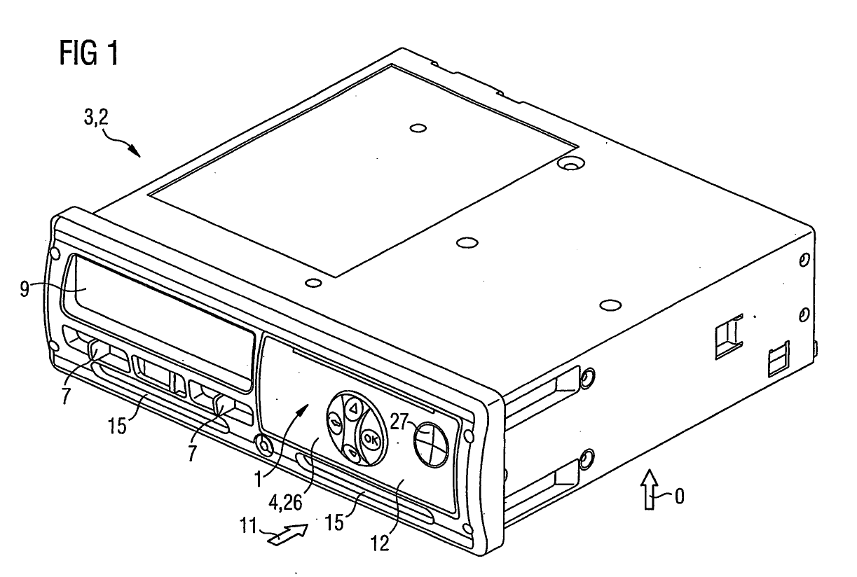

FIG. 1 shows a printer according to the invention as a constituent part of a tachograph arranged in a housing, in a perspective illustration in a view obliquely from above,

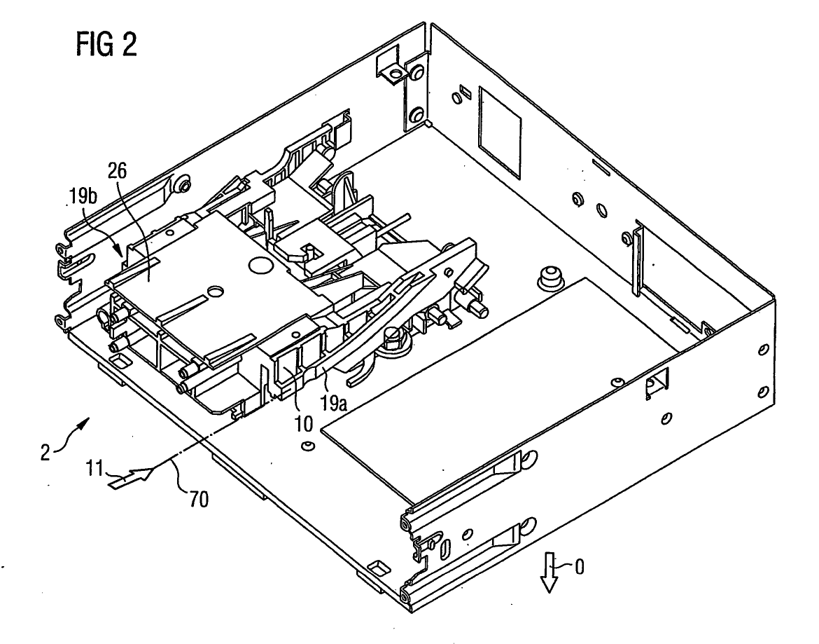

FIG. 2 shows the opened housing of the tachograph illustrated in FIG. 1 with the arrangement of the carrier of the media unit, lateral guidance of the media unit, and of the locking unit in a view obliquely from below,

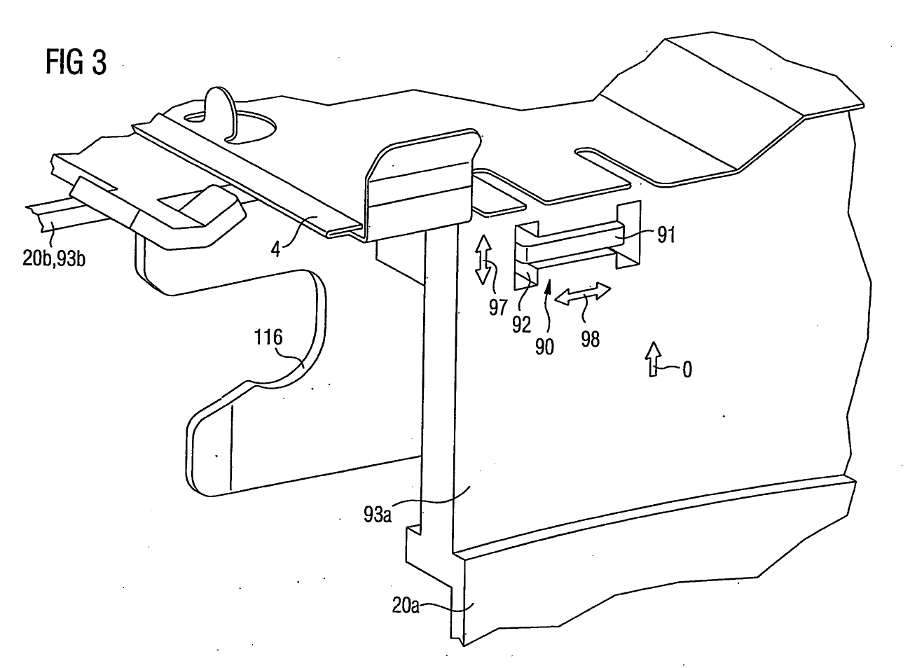

FIG. 3 shows a perspective illustration of a mounting of the printing unit in a view obliquely from above,

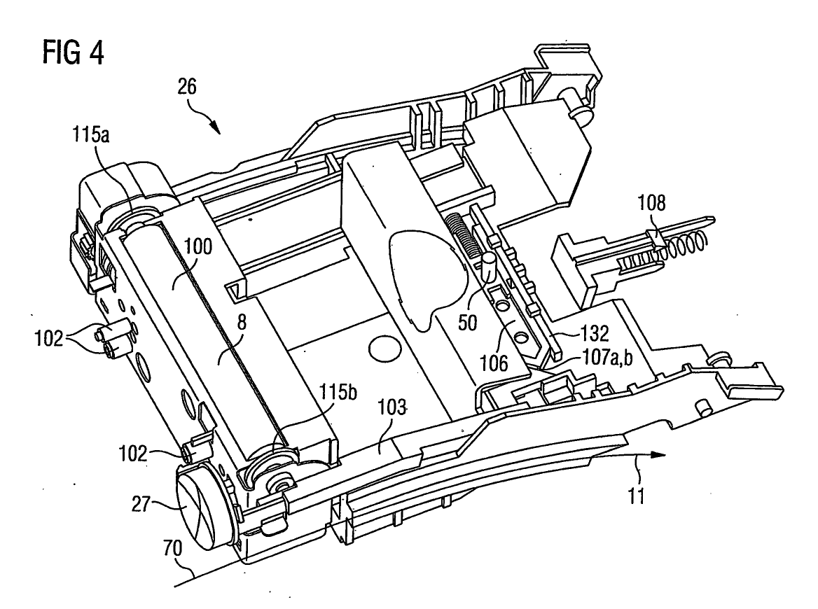

FIG. 4 shows a perspective illustration of the media unit with the holder for a coiled strip, a part of the locking unit and of the resilient element for ejecting the media unit from the housing, in a view obliquely from above,

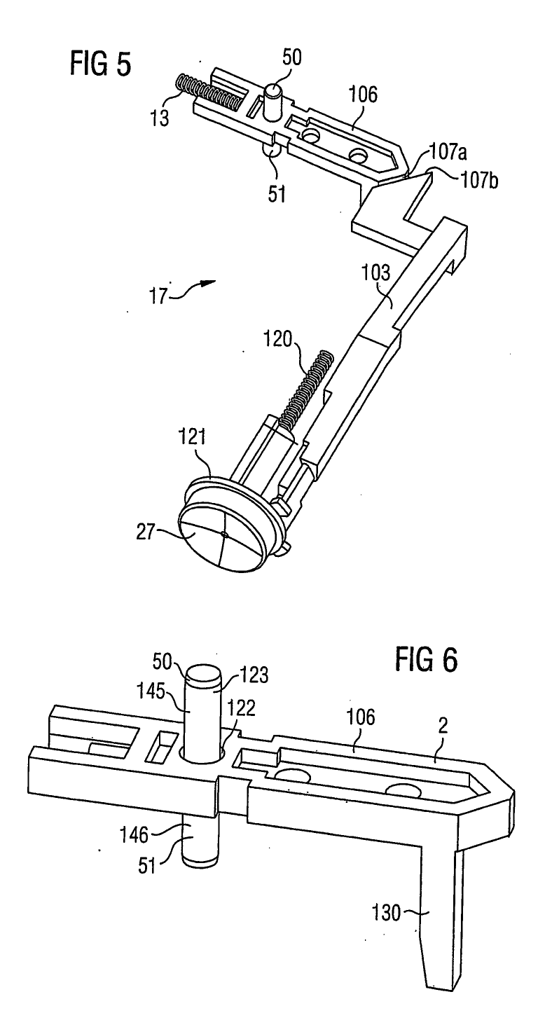

FIG. 5 shows an isolated perspective illustration of the operating element of the locking unit, of a transmission slide of the locking unit, of the carriage of the locking unit, of the locking element and of a first resilient element, in a view obliquely from above,

FIG. 6 shows a perspective illustration of the carriage of the locking unit and of a locking element,

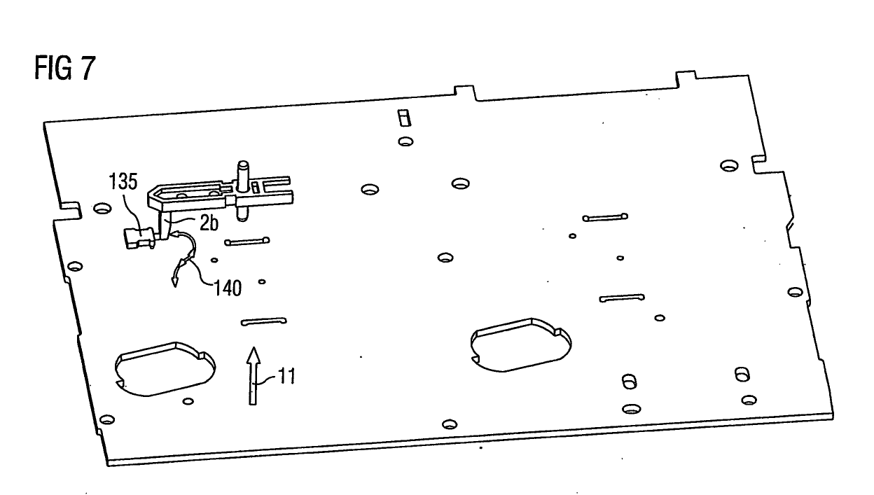

FIG. 7 shows a perspective illustration of the carriage of the locking unit with a locking element according to FIG. 6 in an assembly with a printed circuit board, on which a sensor is arranged,

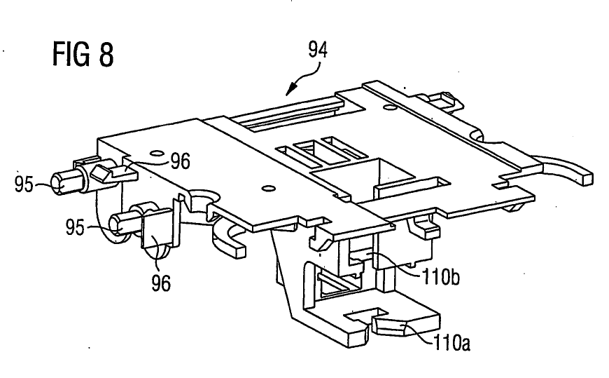

FIG. 8 shows a perspective illustration of a part of the locking unit fixed to the housing,

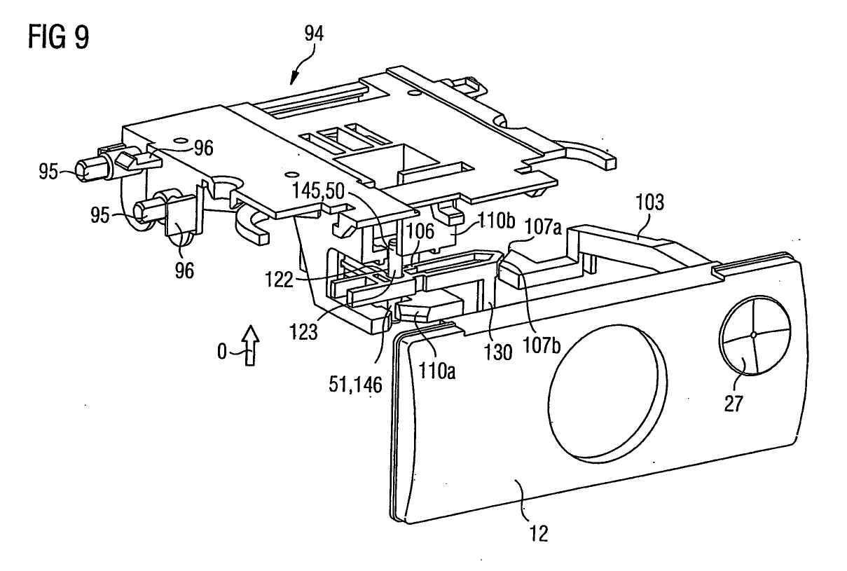

FIG. 9 shows a perspective illustration of the locking unit together with the front panel of the media unit,

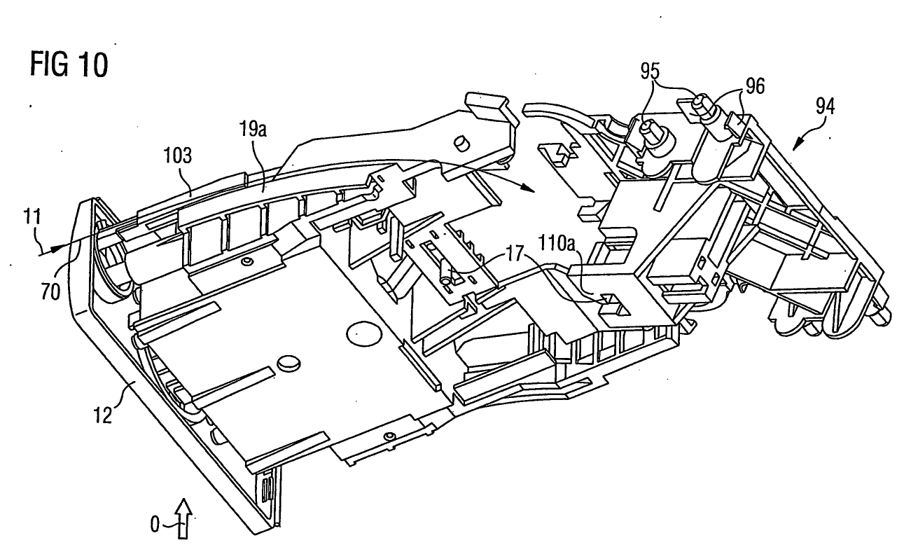

FIG. 10 shows a perspective illustration of the locking unit on the housing side and the media unit side in an assembly with the carrier of the media unit and of the front panel in a view obliquely from below.

In relation to some illustrations, the installed position is pointed out by means of an arrow 0 which points upward. The substantially box-shaped housing 2 illustrated in FIG. 1 is used to hold a tachograph 3 comprising a printer 1. The tachograph is provided with various operating elements 7 and an LCD display unit 9. Beside the LCD display unit 9 there is the front panel 12 of the printer 1. Under the front panel 12 and the LCD display unit 9 there are respectively holding openings 15 for holding a card, not illustrated, comprising a data storage means. The front panel 12 of the printer 1 is a constituent part of a media unit 26 of the printer 1 and carries a first operating element 27 for actuating a locking unit 17 and a second operating element 25 for controlling the function of the printer 1.

In FIG. 2, the housing 2 of FIG. 1 is illustrated in open form perspectively in a view from below, in the interior of the housing 2 only a carrier 10 of the media unit 26, having first guide elements 19a, 19b arranged at the sides, and the media unit 11 being illustrated. For the purpose of improved understanding, the electronics of the tachograph 3, the holding openings 15 for a chip card, second guide elements 20 for guiding the first guide elements 19a, 19b, a transport unit 8 of the media unit 26, as important components, are not illustrated. The media unit 26 can be moved along the insertion curve 17 described by the first guide elements 19a, 19b out of the housing 2 and into an operating position along an insertion direction 11 and counter to this direction. When the operating position is reached, the locking unit 17 latches in, holding the media unit 26 in the operating position in the housing 2.

In FIG. 3, the floating mounting 90 of the printing unit 4, not illustrated in the other figures, is illustrated. The floating mounting 90 comprises a wing-like molding 91 integrally molded on both sides of the printing unit 4, which is in each case arranged in a recess 92 which is a constituent part of a carrier element 93a, which also comprises the second guide elements 20a, 20b corresponding to the first guide elements 19a, 19b. The carrier elements 93a, 93b are firmly connected to a retaining element carrier 94 of the locking unit 17, illustrated in FIG. 8, when they are mounted. In this case, the carrier elements 93a, 93b are centered on pins 95 on both sides of the side of the retaining element carrier 94 and latched by means of latching hooks 96. The moldings 91 arranged on both sides of the printing unit 4 in each case have a vertical movement play 97 of about 0.5 mm in the recesses 92 in the carrier element 93a, 93b, and a horizontal movement play 98 in the insertion direction 11 of about 1 mm. Between the printing unit 4 and the carrier elements 93a, 93b, in addition a horizontal movement play of a total of 1 mm transversely with respect to the insertion direction is provided. It would be to the advantage of printing quality if the horizontal movement play in the insertion direction 11 and transversely thereto were in each case reduced to about 0.5 mm, but this would increase the expenditure on fabrication as compared with the movement play selected. In the same way, it is conceivable with a functional advantageous to reduce the vertical movement play down to 0.35 mm. In a manner not illustrated, by means of a resilient element not illustrated, the printing unit 4 is prestressed counter to the insertion direction 11 in the recess 92 so as to butt up against the molding 91 of the floating mounting 90, so that the printing units 4 is always located in a defined position, even in the absence of the media unit 26.

In FIG. 4, the media unit 26 is illustrated with its important components, a transport unit 8, the movable parts of the locking unit 17, the carrier 10 and a second resilient element 99 for ejecting the media unit 26. A transport unit 8 of the media unit 26 has a transport roll 100 for the transport of the paper of a coiled strip, not illustrated but arranged in the holding space 101 between transport unit 8 and locking unit 17. Arranged on the front side 104 of the transport unit 8 of the media unit 26 are centering elements 102 for holding the front panel 12 illustrated in FIG. 1. By means of the first operating element 27, an operating slide 103 of the locking unit 17 can be actuated and, in a manner illustrated in FIG. 5, transports a carriage 106 of the locking unit 17 on the actuating slide 103 and on the carriage 106 by means of inclined siding planes 107a, 107b. The media unit 26 is prestressed in the housing 2, counter to the insertion direction 11, by means of a second resilient element 99 which is formed as a spiral spring and which is supported on the retaining element carrier 94 between a first retaining element 110a illustrated in FIG. 8 and a second retaining element 110b.

On both sides of the transport roll 100, on a common shaft 114 holding the transport roll 100, the transport unit 8 has alignment guides 115, which interact with corresponding recesses 116 of the printing unit 4 illustrated as a detail in FIG. 3 during a movement of the media unit 26 in the insertion direction 11, aligning the printing unit 4 in relation to the media unit 26. In the course of this alignment, the printing unit 4 is moved within the horizontal (98) and vertical (98) movement play. In this way, a compensation of the tolerance between the media unit 26 and the printing unit 4 is expediently carried out, which improves the printing quality decisively. In this case, the carriage 106 is guided such that it can be displaced on the carrier 10 of the media unit, slide-mounted along a sliding guide 117. The sliding guide 117 limits the mobility of the carriage 106 to just the translational degree of freedom of the locking movement. In this way, the sliding guide 117 of the carriage 106 is also able to accommodate torques which are input by means of locking elements 50, 51 fixed to the carriage 106.

From the illustration of FIG. 5, it is possible to gather that there is resiliently prestressed mounting of the first operating element 25 by means of a fourth resilient element 120. In the finally mounted state, the fourth resilient element 120 interacts in a sealing manner with a collar 121 on the first operating element 27 and a sealing stop on the front panel 12, which extends in the peripheral direction of the first operating element 27 but is not specifically illustrated. The fourth resilient element 120 is in this case dimensioned and also prestressed in such a way that the arrangement comprising collar 121 and sealing stop of the front panel 12, managing without any additional resilient seal, meets protection class IP 54, in particular is sealed against spray.

A first resilient element 13 of the locking unit 17 ensures a defined position of the locking elements 50, 51 and of the carriage 106 both in a locked position and an unlocked position.

FIG. 6 reveals the construction of the carriage 106 with locking elements 50, 51 and a sensor actuating element 130 in a perspective illustration. The carriage 106 is provided with a cylindrical hole 122, through which there extends a metal pin 123, likewise cylindrical, which projects on both sides of a sliding surface 131 of the sliding guide 117 of the carriage 106. The two projecting ends of the pin 123 embody the locking elements 50, 51.

In the manner illustrated in FIG. 7, the sensor actuating element 150 actuates a sensor switch 135, which is arranged on a common printed circuit board 136 of the device. Within the context of an inward movement along the insertion direction 11 of the carriage 106, the carriage 106 and, with it, the sensor actuating area 130, completes a curved (140) movement in order to actuate the sensor switch 135 along the slot-type guides of the hook profiles of the retaining elements 110a, 110b illustrated in FIG. 8, which force this curved movement (140) on the carriage 106 by means of the guide elements 50, 51. The actual locking movement of the carriage 106 and of the locking elements 50, 51 of the hook-like profiles of the retaining elements 110a, 110b runs perpendicular to the insertion direction 11, so that the restoring force of the second resilient element 99 for the ejection of the media unit has no component in the direction of movement of the locking unit 17. The locking elements 50, 51 arranged on both sides of the sliding surface 131 of the carriage 106, and therefore the contact regions 145, 146 of the locking elements 50, 51, likewise arranged on both sides of this sliding surface 171, on the retaining elements 110a, 110b likewise advantageously permit the transmission of torques oriented transversely with respect to the insertion direction 11 from the carriage 106, which is mounted so as to be stable against torques, to the retaining elements 110a, 110b of the locking unit 17. The second resilient element 99 illustrated in FIG. 4 is arranged between the retaining elements 110a, 110b illustrated in FIG. 8 and symmetrically with respect to the locking elements 50, 51. This arrangement is illustrated once more in FIG. 9 for the purpose of clarification, in particular leaving out the carrier 10 with the torque-stable guidance 132 of the carriage 106.

The perspective illustration of FIG. 10 shows the complete media unit in an overall view with the retaining element carrier 94, leaving out the printing unit 4, so that the action of inserting the media unit 26 along the insertion curve 70 in the insertion direction 11 is illustrated. Subsequently, not illustrated, the locking elements 50, 51 move along the retaining elements 110a, 110b of the locking unit, so that the media unit 26 is retained on the retaining element carrier 94 under the prestress of the second resilient element 108, and thus in a locked position in the housing.

1. A printer for a tachograph of a motor vehicle, the printer comprising:
a housing,
a printing unit, having a media unit arranged to hold the medium that can be printed, the media unit is further arranged to be moved relative to the printing unit along an insertion curve describing an insertion direction into an operating position and, counter to the insertion direction, out of an operating position, the media unit further arranged to be at least partly removed from the housing and locked in an operating position in the housing (2) by means of a locking unit, the locking unit comprising, at least one movable locking element arranged to be moved into a locked position and into an unlocked position, the locking element in the locked position engaging with at least one retaining element which is fixed to the housing, and
wherein the locking element is arranged to be moved translationally transversely with respect to the insertion direction into a locked position and into an unlocked position.

2. The printer according to claim 1, wherein the printer comprises two retaining elements arranged with a spacing from each other which, in the locked position, engage with at least one locking element.

3. The printer according to claim 1, further comprising, a first resilient element which pushes or pulls the locking element into the locked position and prestresses it.

4. The printer according to claim 1, wherein the locking unit further comprises a slide-mounted carriage arranged to carry at least one locking element and be moved into a locked and unlocked position.

5. The printer according to claim 1, wherein at least one locking element is fixed to the carriage and extends substantially perpendicular to the direction of movement of the carriage.

6. The printer according to claim 1, wherein the locking elements fixed to the carriage have at least two contact regions, with which they bear on the retaining elements in the locked position, the direction of the spacing between the two contact regions describes a straight line running substantially perpendicular to the direction of movement of the carriage.

7. The printer according to claim 6, wherein the carriage is slide-mounted on at least one sliding plane and the sliding plane extends between the two contact regions, so that at least one locking element is arranged on both sides of the sliding mounting of the carriage.

8. The printer according to claim 7, wherein the two contact regions are located substantially on a single straight line described by a normal to the sliding plane of the carriage.

9. The printer according to claim 6, wherein the media unit is mounted such that it can be displaced along the insertion curve in guides, the direction of the spacing between the two contact regions of the locking unit extends substantially in the direction of the normal to the tangential plane described by the guides.

10. The printer according to claim 1, wherein the media unit comprises an operating front facing the user, into which an operating element of the locking unit is integrated, by means of which the locking unit can be moved into a locked position and into an unlocked position.

11. The printer according to claim 1, wherein the locking unit further comprises a cylindrical shape and the cylinder longitudinal axis is arranged to run perpendicular to the direction of movement.

12. The printer according to claim 1, wherein the movable locking element on the media unit is a fixed component part of the media unit.

13. The printer according to claim 1, wherein the stationary retaining element is permanently connected to the housing and interacts in a locking manner with the locking elements on the media unit.

14. The printer according to claim 1, wherein the retaining element has at least one hook-like slotted guide, along which the locking elements move as they move into the locked position.

15. The printer according, to claim 1, wherein the movable parts of the locking unit interact with a sensor which registers a locked position, in which the media unit or the carrier and the printing unit are fixed in relation to each other in the direction of the spacing and/or an unlocked position, in which the media unit or the carrier and the printing unit are not fixed in relation to one another in the direction of the spacing.

16. The printer according to claim 1, wherein the printing unit is arranged to be moved in the housing within a movement play, in that means for aligning the printing unit with the media unit are provided, so that the printing unit and the media unit are aligned in relation to each other when the media unit is inserted in the insertion directions.

17. The printer according to claim 1, wherein the printing unit is arranged to be moved in the housing in the insertion direction and counter to the insertion direction and/or transversely with respect to the insertion direction to the extent of a substantially horizontal movement play.

18. The printer according to claim 1, wherein characterized in that the printing unit is arranged to be moved transversely with respect to the insertion direction in the housing to the extent of a substantially vertical movement play.

19. The printer according to claim 15, wherein the horizontal movement play in the insertion direction and/or transversely with respect to the insertion direction is between 0.5 mm and 1.5 mm.

20. The printer according to claim 17, wherein the vertical movement play transversely with respect to the insertion direction is between 0.2 mm and 0.5 mm.

21. The printer according to claim 1, wherein the printing unit is mounted in a floating manner in the housing.

22. The printer according to claim 1, wherein the printer comprises at least one second resilient element arranged to push or pull the printing unit counter to the insertion direction with a force which urges the printing unit against the media unit when the latter is inserted.

23. The printer according to claim 21, wherein the locking unit comprises at least two retaining elements, which are arranged symmetrically with respect to the second resilient element.

24. The printer according to claim 1, wherein the second resilient element is arranged to prestress the printing unit in the housing against stops limiting the movement play when the media unit is not in the operating position, so that the printing unit is always located in a defined position in the absence of the media unit.

25. The printer according to claim 1, wherein the printer comprises at least one guide having at least two first guide elements arranged on the media unit and two second guide elements corresponding to the first guide elements on the media unit arranged such that, during a movement in or counter to the insertion direction, the media unit is guided by means of the guide.

26. (canceled)
